(19) United States
(12) Patent Application Publication
(10) Pub. No.: US 2011/0287178 A1
(43) Pub. Date: Nov. 24, 2011

(54) DEPOSITION PROCESS

(75) Inventors: Simon James Hurst, Cheshire (GB); Guillermo Benito Gutierrez, Madrid (GB); Troy Darrell Manning, Lancashire (GB); Kevin David Sanderson, Lancashire (GB)

(73) Assignee: PILKINGTON GROUP LIMITED, St. Helens (GB)

(21) Appl. No.: 12/452,150

(22) PCT Filed: Jul. 4, 2008
(86) PCT No.: PCT/GB2008/050538

§ 371 Date: Jul. 23, 2010

(30) Foreign Application Priority Data
Jul. 6, 2007 (GB) 0713118.8
Apr. 30, 2008 (GB) 0807842.0

(51) Int. Cl. B05D 5/06

(52) U.S. Cl. 427/162

(57) ABSTRACT

Anti reflective silica coatings are deposited on the glass ribbon produced during a float glass or a rolled glass production process using a flame pyrolysis deposition process which is preferably a combustion chemical vapour deposition process. The temperature of the ribbon is greater than 200° C. The process may be carried out in the gap between the float bath or rollers and the annealing lehr. The durability of the coating may be increased by sintering. The equipment preferably comprises an extraction unit positioned adjacent to each burner head. In a further embodiment additional oxygen is introduced to the vapour deposition process in order produce a coating having a lower effective refractive index.

This invention relates to novel processes for the deposition of an anti reflective coating upon the surface of a continuous glass ribbon. In a preferred embodiment the coating comprises an oxide of a metal or a metalloid.

Reduced reflections are a desirable feature of many optical systems. Anti reflection coatings which do not reduce the transmission of incident light are a desirable feature of devices such as the covers for solar panels and photovoltaic cells.

The degree of anti reflection which is provided by a coating comprising a single layer of material on the surface of a substrate is highest if the refractive index of the material corresponds to the square root of the refractive index of the substrate. Glass substrates typically have a refractive index of 1.5. In order to be useful as an anti reflective coating the coating material preferably has a refractive index which is in the range of from 1.25 to 1.40.

These low refractive indexes cannot be attained using dense coating materials. They can be achieved using less dense porous coating materials and in particular porous silica coatings. The deposition of such porous coatings is not straightforward. The deposition processes which have been proposed involve the use of a sol gel type of process in which a silica sol is coated onto the surface of a substrate and heated at elevated temperature so as to drive off organic material and result in the production of the anti reflective silica coating. Processes of this type have been disclosed in EP 1429997, DE 10146687, EP1328483 and U.S. Pat. No. 6,918,957 amongst others and are in commercial use. However the process is time consuming and the cost of production is relatively high. Moreover the coatings produced may be insufficiently durable to resist secondary glass processing such as toughening and laminating processes without significant deterioration in their properties.

There exists a need in the art for a process by which an anti reflection coating which exhibits improved durability and which can be deposited rapidly onto a substrate thereby lowering the costs of producing the coated substrate.

USPA 2006/003108 discloses a process for depositing a reflection reducing coating onto the surface of a glass substrate in which a silicon containing precursor is decomposed with a flame and the substrate is introduced into the flame so as to apply the precursor to the substrate directly from the gas phase as an SiOₓ (OH)₄₋ₓ coating wherein 0<x≦2. The processes are used to coat glass panes which are passed repeatedly through the flame in order to deposit a coating having the desired properties.

Processes for the deposition of dense silica coatings having a refractive index of 1.45 or greater on to the glass ribbon formed during a float glass production process are well known in the art. Examples of such processes are disclosed in WO 2005/023723. Such processes produce coated glass at the rate at which the ribbon is produced and are thereby economically attractive. However the coatings are dense and have too high a refractive index to be useful as an anti reflection coating.

We have now discovered that an anti reflection coating may be deposited upon the surface of a glass ribbon produced as part of a float glass process or a rolled glass process using a combustion chemical vapour deposition process. Such processes may be used on a continuous or a semi continuous basis and thereby provide a more economic production process.

From a first aspect this invention provides a process for the deposition of an anti reflection coating upon at least one surface of a continuous glass ribbon produced as part of a float glass process or a rolled glass process characterised in that said anti reflection coating is deposited using a flame pyrolysis deposition process.

Flame pyrolysis deposition processes comprise the steps of forming a fluid mixture comprising a precursor of an oxide of a metal or a metalloid, an oxidant and a comburant. This fluid mixture is then ignited at a point which is adjacent to the surface of the substrate. The precursor for the oxide may be any compound of a metal or metalloid which may be dispersed in the fluid mixture and which will decompose to form an oxide when the mixture is ignited. Processes in which the precursor is in the vapour phase are commonly termed combustion chemical vapour deposition processes (hereinafter for convenience CCVD processes). In a preferred embodiment the processes of this invention are CCVD processes.

The anti reflection layers preferably have a refractive index of from 1.25 to 1.40. The effective refractive index varies with the porosity and the surface roughness of the deposited coating. These parameters are influenced by the temperature of the glass ribbon, by the material from which the anti reflection layer is formed and the precursor of that material which is used and by the conditions under which the CCVD process is carried out.

The thickness of the anti reflection coatings is preferably from 10 to 500 nm and more preferably from 50 to 250 nm. The thickness of the coating is preferably that which will result in destructive interference between the light reflected from the surface of the coating and the surface of the glass. For optimum destructive interference the length of the lights optical path in the coating should be equal to one half of the wavelength of the light. This thickness can be calculated from the equation

t=λ/4n where t is the thickness of the coating, λ is the wavelength of the incident light and n is the refractive index of the coating.

We have discovered that one processing condition which can exert a significant effect upon the refractive index of the coating which is deposited is the temperature of the surface of the glass ribbon on to which the anti reflection coating is deposited. In the preferred embodiments this temperature will be in the range 200° C. to 750° C. and more preferably in the range 200° C. to 650° C. We have discovered that coatings which are deposited on to a glass surface having a higher temperature may have a lower refractive index and exhibit greater durability and are thereby more useful as an anti reflection coating.

The glass ribbon upon which the antireflective coating is deposited in the processes of this invention may be any glass ribbon which is manufactured using a float glass process or a rolled glass process. The glass may be a soda lime float glass, a low iron float glass typically comprising less than 0.015% by weight of iron which provides increased visible light transmission compared to float glass or a body tinted float glass comprising a higher proportion of iron, cobalt or selenium which has a green, grey or blue colouration. The glass ribbon may have a coating comprising one or more layers of a metal oxide or a silicon oxide deposited on its surface prior to the deposition of the antireflection coating. Glass having coatings comprising metal oxide or silicon oxides exhibit improved solar control or thermal properties and may be manufactured using atmospheric chemical vapour deposition processes carried out in the float bath. The processes of this invention may be used to deposit an anti reflection coating on top of such an existing coating or onto the uncoated reverse face of a coated glass ribbon. In this invention the coating is applied to the glass ribbon which is formed during a rolled glass production process or during a float glass production process. These glass ribbons typically have a thickness of from 0.5 mm to 25 mm more commonly of from 2 mm to 20 mm and a visible light transmission of from 10.0% to 90.0% or 94.0%. We have discovered that the exposure of the glass ribbon to a flame prior to it entering the lehr in which the ribbon is annealed to relieve stresses does not significantly alter the quality of the product. It is thereby possible to deposit an anti reflection coating onto the ribbon using the processes of this invention at the point between the rollers and the entrance to the lehr in a rolled glass process or between the float bath and the entrance to the lehr in a float glass process. The temperature of the glass at this point is generally in the range 300° C. to 750° C. Such processes enable an anti reflection coating to be applied more quickly and economically than was previously possible and they thereby represent a preferred aspect of the present invention. The coated glass may have a visible light transmission which is from 1% to 3.5% greater than the glass before the coating was applied.

The coating must be sufficiently durable so as to be useful. The durability of the coating may be increased by sintering the coating at a temperature in the range of from 300° C. to 1600° C. A sintering process may reduce the light transmission of the coated glass to a degree but this reduction may be acceptable in order to ensure that the coating is sufficiently durable.

The CCVD process may be carried out by passing the fluid mixture to a burner which is positioned above or below the surface of the glass ribbon. The burner preferably extends across the full width of the ribbon although a series of smaller burners may be used provided that the ribbon is coated evenly. The burner is preferably positioned above the ribbon in close proximity to the surface of the glass ribbon. The distance between the burner and the ribbon will typically be in the range of from 2 to 20 mm and preferably in the range 5.0 to 15.0 mm. Such close proximity results in a coating having improved properties possibly because it minimises the amount of recombination between the species produced by burning the precursor before they are deposited upon the surface of the substrate. It may be necessary to adjust the distance between the burner and the surface of the glass ribbon in order to optimise the properties of the desired coating. A plurality of burners positioned along the length of the ribbon may be used in order to deposit a coating having the desired thickness. The burners which are available for use in known flame pyrolysis processes are useful in the processes of this invention.

The burner is preferably associated with means for extracting the exhaust gases from the area adjacent to the surface of the glass. In the preferred embodiments at least one means for extraction is positioned adjacent to each burner. The extraction means is typically a conduit associated with a fan which produces an updraft at the mouth of the conduit. Each extraction means is preferably provided with control means whereby the draft provided may be adjusted. In the preferred embodiments of the invention the extraction means are controlled so as to isolate the burner flames from each other, to control the direction of the flame so as to optimise the impingement of the flame over the surface of the glass and to efficiently remove the by products which are generated by the combustion. Where a single conduit is associated with a burner it is preferably positioned upstream of the conduit but in the preferred embodiments exhaust conduits are provided both upstream and downstream of each burner head.

The Applicants have discovered that the quality of the coating which is deposited can be improved by extracting the exhaust gases in a manner which causes the tail of the flame to be positioned above the surface of the glass i.e. when the burner is located above the glass surface the tail of the flame is also located above the glass surface and when the burner is located below the glass surface the tail of the flame is also below the glass surface. Extracting the gases in this way has been found to reduce powder formation and to improve the uniformity of the coating. These are significant advantages in an on line coating process where a high deposition speed is a necessity.

The temperature of the flame varies with the choice of comburant. Any gas which can be burnt to and generate a sufficiently high flame temperature to decompose the precursor is potentially useful. Generally the comburant will be one which generates a flame temperature of at least 1700° C. The preferred comburants include hydrocarbons such as propane, acetylene, methane and natural gas or hydrogen.

The comburant may be burnt in any gas which comprises a source of oxygen. Typically the comburant will be mixed with and burnt in air. The ratio of comburant to air may be adjusted so that the flame is either oxygen rich or oxygen deficient. The use of an oxygen rich flame favours the production of a fully oxidised coating whereas the use of an oxygen deficient flame favours the production of a coating which is less than fully oxidised.

The preferred anti reflection layers which are deposited in the processes of this invention comprise an oxide of silicon. In these preferred embodiments the temperature of the surface of the glass ribbon during the deposition process is in the range 200° C. to 650° C. and more preferably in the range 400° C. to 650° C.

Examples of precursors which may be used in the formation of silica coating include compounds having the general formula SiX₄ wherein the groups X which may be the same or different represent a halogen atom especially a chlorine atom or a bromine atom, a hydrogen atom, an alkoxy group having the formula —OR or an ester group having the formula —OOCR wherein R represents an alkyl group comprising from 1 to 4 carbon atoms. Particularly preferred precursors for use in the present invention include tetraethoxysilane (TEOS), hexamethyldisiloxane and silane.

The thermal output of the burners useful in the processes of this invention may be from 0.5 to 10 Kw/10 cm², preferably from 1 to 5 Kw/10 cm². The concentration of precursor in the fluid mixture which is delivered to the burner is typically from 0.05 to 25 vol %, preferably from 0.05 to 5 vol % gas phase concentration.

The Applicants have further discovered that the growth and properties of an anti reflection coating which is deposited using a flame pyrolysis process may be improved by the addition of oxygen to the mixture comprising the precursor, the comburant and an oxidant. This addition of oxygen in a quantity which is additional to that required to produce a fully oxidised coating has been discovered to influence the degree of particle agglomeration in the coating. The morphology and effective refractive index of the coating may be optimised by the controlled addition of oxygen.

Thus from a second aspect this invention provides a process for the deposition of an anti reflection coating upon the surface of a continuous glass ribbon wherein said coating is deposited using a flame pyrolysis deposition process comprising the steps of forming a fluid mixture comprising a precursor of a metal or a metalloid, an oxidant and a comburant and igniting said fluid mixture at a point adjacent to the surface of the glass ribbon characterised in that an additional quantity of oxygen is introduced into the fluid mixture prior to its ignition.

This addition of oxygen is particularly effective when it is added to a mixture comprising a precursor, a comburant and air as the oxidant. The addition of oxygen has only a minor impact upon the gas velocity through the burner but has a relatively significant increase upon the flame front velocity. Without wishing to be bound by any theory the Applicants believe that an increase in the flame front velocity has the effect of reducing the recombination of the particles.

The controlled addition of oxygen can be used to optimise the growth and properties of the anti reflection coating. The addition of an excessive quantity of oxygen has been found to lead to an increase in the effective refractive index of the coating possibly due to the flame front velocity increasing to a point at which sintering of the particles occurs. The optimum amount of oxygen which should be added to any particular precursor mixture being burnt in a particular burner using a particular extraction means may be determined by routine experiment.

The amount of oxygen which may be added to the system may be expressed as a parameter λ where the value of λ may be represented by the equation

$$λ = \frac{[ {O}_{2} ] air + [ {O}_{2} ] gas}{[ {O}_{2 } ] comburant + [ {O}_{2} ] precursor}$$

where the denominator represents the total amount of oxygen required for the complete oxidation of the comburant and the precursor and the numerator is the summation of the amount of oxygen supplied in the air fed to the burner and the amount of oxygen which is added to the fluid mixture prior to is combustion. In general the value of λ preferably lies in the range 1.3 to 2.0 and more commonly in the range 1.5 to 1.9.

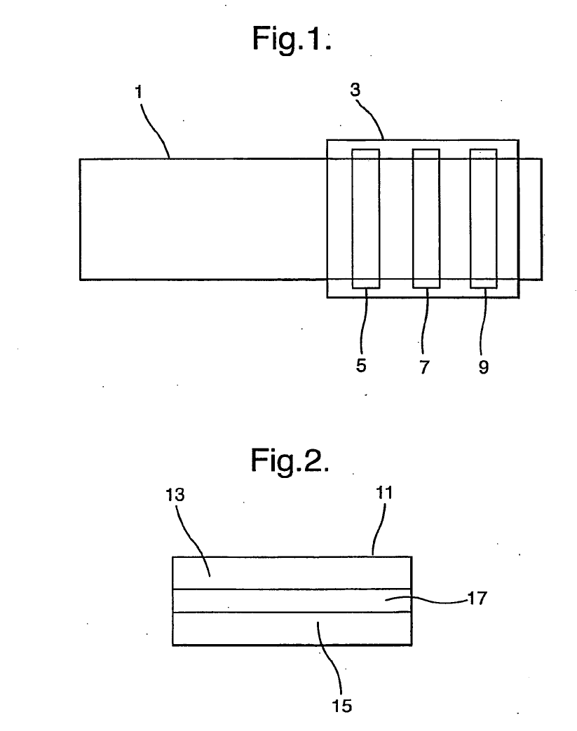

The invention is illustrated by the following Examples which utilised the equipment represented diagrammatically in FIGS. 1 to 4.

FIG. 1 is a plan view of a glass ribbon passing beneath a series of three burner heads mounted above the ribbon. FIG. 2 is a plan view of a burner head.

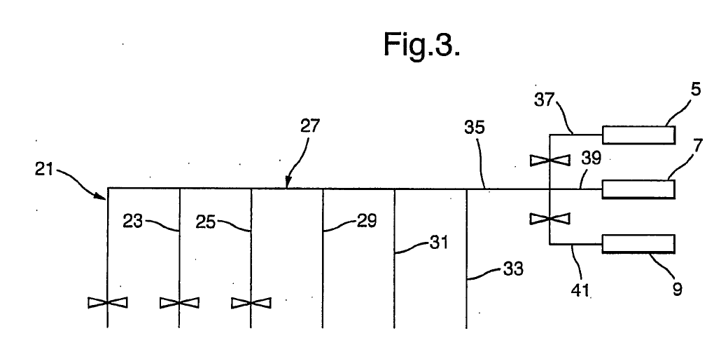

FIG. 3 is diagrammatic representation of a delivery unit used to deliver a fluid mixture to the burner heads.

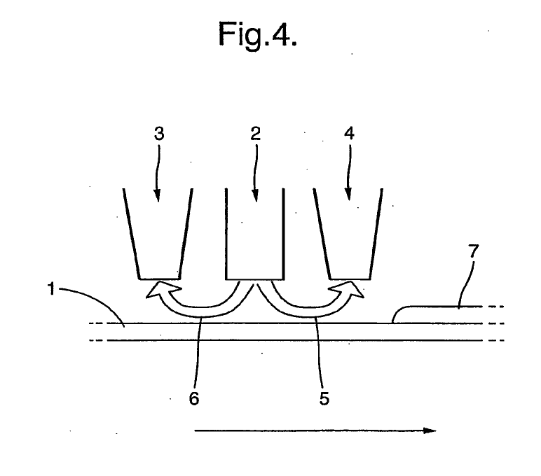

FIG. 4 is a side elevation of a glass ribbon passing beneath a burner head having extraction means on either side.

In FIG. 1 the ribbon 1 is shown emerging from the float bath and passing beneath a burner frame 3. Burner heads 5, 7 and 9 are mounted under burner head 3. The temperature of the ribbon under burner head 5 was approximately 620° C., under head 7 it was approximately 610° C. and under head 9 it was approximately 607° C. The ribbon was moving at a speed of 3.7 meters per minute.

FIG. 2 is a plan view of a burner head. The head 11 comprises three sections 13, 15 and 17 each having a separate supply line (not shown) through which a fluid mixture may be fed. A mixture comprising propane and air is fed to sections 13 and 15. A fluid mixture comprising propane, air and hexamethyldisiloxane (hereinafter HMDSO) is fed to Section 17.

FIG. 3 shows gas lines 21, 23 and 25 through which flow streams of inert gas, oxygen containing gas and comburant gas. These flows are combined into line 27. Flows of precursor(s) fed through lines 29, 31 and 33 combine with the flow in line 27 to form a fluid mixture which flows through line 35. The flow in line 35 may be split into three streams which flow through lines 37, 39 and 41 to burner heads 5, 7 and 9.

FIG. 4 shows glass ribbon 1 passing under burner 2 and having a silica anti reflection coating 7 deposited on to its upper surface. Fish tail extraction conduits 3 and 4 are positioned both upstream and downstream of burner 2. Each conduit 3 and 4 is equipped with a fan (not shown) which creates an updraft through the conduit. Arrows 5 and 6 represent the passage of the flame when the extractors 3 and 4 are both functioning.

A series of 6 deposition processes were carried out using the equipment represented in FIGS. 1, 2 and 3. The precursor was HMDSO. HMDSO was volatilised by passing air through a heated bubbler containing HMDSO. The vapour produced was fed through line 31. The details of the process are summarised below as Table 1. The properties of the coated glass produced are summarised in Table 2.

TABLE 1

| | | | | Litres/min air flow |
|---|---|---|---|---|
| Example | Air Flow | | | through HMDSO |
| No | (litres/min) | Burners | Air/Propane | Bubbler |
| 1 | 50 | 5, 7 and 9 | 25:1 | 0.0 |
| 2 | 50 | 5, 7 and 9 | 25:1 | 6.5 |
| 3 | 50 | 5, 7 and 9 | 25:1 | 3.5 |
| 4 | 50 | 5, 7 and 9 | 25:1 | 2.5 |
| 5 | 50 | 5, 7 and 9 | 25:1 | 1.2 |
| 6 | 50 | 5, 7 and 9 | 25:1 | 0.5 |
| 7 | 50 | 5, 7 and 9 | 25:1 | 0.35 |

TABLE 2

| | | | | | Rvis |
|---|---|---|---|---|---|
| | | | | | (reduction |
| Example No | % Rvis | a* | b* | L* | from clear) |
| 1 | 9.2 | −0.5 | −0.4 | 36.4 | |
| 2 | 9.0 | −0.7 | −0.5 | 36.0 | 0.2 |
| 3 | 8.7 | −0.7 | −0.1 | 35.4 | 0.5 |
| 4 | 8.3 | −0.6 | 0.3 | 34.7 | 0.9 |
| 5 | 8.3 | −0.6 | 0.5 | 34.7 | 0.9 |
| 6 | 8.8 | −0.7 | −0.1 | 35.6 | 0.4 |
| 7 | 9.2 | −0.6 | −0.5 | 36.3 | 0.1 |

A further series of Examples were carried out using the equipment represented in FIG. 4. The conditions used and the results obtained are set out in Table 3.

TABLE 3

| Exam- | | | | | Line | | Extraction | Extraction | | | | | Uni- | Pow- |
|---|---|---|---|---|---|---|---|---|---|---|---|---|---|---|
| ple | HMDSO | HMDSO | PrH | Air | T | Extraction | Up/Down | Distance | Extraction | Furnace | Speed | | formity | der |
| No | (° C.) | (SLM) | (SLM) | (SLM) | (° C.) | Design | % open | To burner | Baffles | T (° C.) | m/h | % R | (0-5) | (0-5) |
| 8 | 60 | 4 | 1.6 | 40 | 200 | N/A | N/A | N/A | N/A | 650 | 40 | 7.18 | 1 | 2 |
| 9 | 60 | 6 | 1.6 | 40 | 200 | Mk1 | 100/100 | 30 | No | 650 | 40 | 7.43 | 2 | 3 |
| 10 | 60 | 7 | 1.6 | 40 | 200 | Mk1 | 80/100 | 30 | No | 650 | 40 | 7.16 | 2 | 4 |
| 11 | 60 | 8 | 1.6 | 40 | 200 | Mk2 | 80/100 | 30 | Yes | 650 | 40 | 6.70 | 3 | 4 |
| 12 | 60 | 3 | 1.6 | 40 | 120 | Mk3 | 80/100 | 10 | Yes | 650 | 40 | 5.81 | 4 | 4 |

Uniformity and Powder built up are estimated using a relative scale where 0 is poor and 5 is best. At this point is only an indication of performance.

These examples utilised three different extraction models. Mk1 is a fish tail fin with no baffles inside, Mk2 is a long fish tail plus a number of baffles alternating position to equalise the pressure, Mk3 is equivalent to Mk2 but a step in the extraction was generated to allow run the extraction as close to the burner as physically possible.

A further series of Examples were carried out using equipment which comprised 6 burners each of which was provided with extraction means in both the upstream and downstream directions. The extraction means comprised a passageway having a fan associated with it. The speed of the fan was used to regulate the extraction. Each burner was provided with a passageway through which oxygen could be introduced. The temperature of the glass as it passed under the first of these burners was 638° C.

In a first series of experiments Examples 13 to 15 were carried our using a single burner. The fans driving the extraction were run at 50% of their maximum speed. The details and the results are presented as Table 4.

TABLE 4

| | | HMDSO | | N2 Carrier | Propane | Air | O2 | | |
|---|---|---|---|---|---|---|---|---|---|
| | | (ml/min | | Gas | per | per | (SLM) | | |
| Example | HMDSO | per | HMDSO | Flow | burner | burner | per | | |
| No | TOTAL | Burner) | (SLM) | (SLM) | SLM | SLM | burner | λ | % R |
| 13 | 4.90 | 4.9 | 0.52 | 40 | 10.00 | 360.00 | 0.00 | 1.35 | 7.65 |
| 14 | 2.40 | 2.4 | 0.25 | 40 | 10.00 | 360.00 | 0.00 | 1.43 | 7.67 |
| 15 | 18.80 | 18.8 | 1.98 | 40 | 10.00 | 360.00 | 0.00 | 1.02 | 7.79 |

A further series of experiments Examples 16 to 20 were carried out using all six burners. The fans driving the extraction were run at 100% of their maximum speed. Example 16 used air as the only source of oxygen. Examples 17 to 20 comprised the addition of oxygen gas into the fluid mixture. The details and the results of these experiments are presented as Table 5.

TABLE 5

| | | HMDSO | | N2 Carrier | Propane | Air | O2 | | |
|---|---|---|---|---|---|---|---|---|---|
| | | (ml/min | | Gas | per | per | (SLM) | | |
| Example | HMDSO | per | HMDSO | Flow | burner | burner | per | | |
| No | TOTAL | Burner) | (SLM) | (SLM) | SLM | SLM | burner | λ | % R |
| 16 | 4.90 | 0.8 | 0.09 | 40 | 10.00 | 360.00 | 0.00 | 1.48 | 7.54 |
| 17 | 4.90 | 0.8 | 0.09 | 40 | 10.00 | 360.00 | 5.00 | 1.58 | 6.57 |
| 18 | 4.90 | 0.8 | 0.09 | 40 | 10.00 | 360.00 | 10.00 | 1.68 | 6.14 |
| 19 | 4.90 | 0.8 | 0.09 | 40 | 10.00 | 360.00 | 15.00 | 1.78 | 6.20 |
| 20 | 4.90 | 0.8 | 0.09 | 40 | 10.00 | 360.00 | 20.00 | 1.87 | 6.79 |

1-30. (canceled)

31. A process for the deposition of an anti reflection coating upon at least one surface of a continuous glass ribbon produced as part of a float glass process or a rolled glass process wherein said anti reflection layer is deposited using a flame pyrolysis deposition process.

32. The process according to claim 31, wherein the anti reflection layer is deposited using a combustion chemical vapour deposition process.

33. The process according to claim 31, wherein the anti reflection layer has a refractive index of from 1.25 to 1.40.

34. The process according to claim 31, wherein the anti reflection layer comprises an oxide of a metal or a metalloid.

35. The process according to claim 34, wherein the anti reflection layer comprises an oxide of silicon.

36. The process according to claim 31, wherein the temperature of the surface of the ribbon on which the coating is deposited is in the range of from 200° to 650° C.

37. The process according to claim 31, wherein the anti reflection layer has a thickness of from 10 to 500 nanometres.

38. The process according to claim 37, wherein the anti reflection layer has a thickness of from 50 to 250 nanometres.

39. The process according to claim 31, wherein the glass ribbon is a soda lime glass ribbon.

40. The process according to claim 39, wherein the substrate is a glass ribbon formed as part of a rolled glass production process.

41. The process according to claim 40, wherein the glass ribbon comprises less than 0.015% by weight of iron.

42. The process according to claim 39, wherein the substrate is a glass ribbon formed as part of a float glass production process.

43. The process according to claim 31, wherein the glass ribbon is a ribbon having a coating comprising at least one transparent layer on at least one surface and the anti reflection layer is deposited on top of the coating.

44. The process according to claim 31, wherein the flame pyrolysis deposition process comprises the steps of forming a fluid mixture comprising a precursor of an oxide of a metal or a metalloid, a comburant and a source of oxygen, passing said fluid mixture to a burner mounted adjacent to the surface of the glass ribbon and igniting the fluid mixture thereby depositing a layer comprising an oxide of the metal or metalloid onto the surface of the ribbon.

45. The process according to claim 44, wherein at least one means for extracting the exhaust gases is positioned adjacent to each burner.

46. The process according to claim 44, wherein extractions means are provided both upstream and downstream adjacent to each burner.

47. The process according to claim 45, wherein when the extraction means are operational the burner flames are isolated from one another.

48. The process according to claim 44, wherein the fluid mixture comprises at least one precursor which is a compound of silicon.

49. The process according to claim 44, wherein the fluid mixture comprises a compound which has a decomposition temperature which is below that of the flame temperature generated when the fluid mixture is ignited.

50. The process according to claim 44, wherein the fluid mixture comprises a compound selected from the group consisting of tetraethylorthosilicate, hexamethyl disiloxane and silane

51. The process according to claim 44, wherein the comburant is selected from the group consisting of propane, acetylene, methane, natural gas and hydrogen.

52. The process according to claim 44, wherein the comburant is selected so as to provide a flame temperature of at least 1700° C.

53. The process according to claim 44, wherein the fluid mixture comprises from 0.05 to 25 vol % of a precursor of an oxide of a metal or a metalloid.

54. The process according to claim 53, wherein the fluid mixture comprises from 0.05 to 5 vol % of the precursor.

55. The process according to claim 53, wherein the precursor is a compound selected from the group consisting of tetraethylorthosilicate, hexamethyl disiloxane and silane.

56. A process for the deposition of an anti reflection coating upon the surface of a continuous glass ribbon wherein said coating is deposited using a flame pyrolysis deposition process comprising the steps of forming a fluid mixture comprising a precursor of a metal or a metalloid, an oxidant and a comburant and igniting said fluid mixture at a point adjacent to the surface of the glass ribbon wherein an additional quantity of oxygen is introduced into the fluid mixture prior to its ignition.

57. The process according to claim 56, wherein the oxidant in the fluid mixture is air.

58. The process according to claim 56, wherein the additional oxygen is introduced in the form of oxygen gas.

59. The process according to claim 56, wherein the amount of oxygen which is added to the fluid mixture is controlled in order to produce a coating having a particular effective refractive index is determined empirically.
